(19) United States
(12) Patent Application Publication
(10) Pub. No.: US 2014/0358709 A1
(43) Pub. Date: Dec. 4, 2014

(54) Card Present Transaction Authentication by Short Messaging Service

(71) Applicant: MASTERCARD ASIA PACIFIC PTE. LTD., SINGAPORE (SG)

(72) Inventor: Wilianto Wu, Singapore (SG)

(73) Assignee: MASTERCARD ASIA PACIFIC PTE. LTD., SINGAPORE (SG)

(21) Appl. No.: 14/291,538

(22) Filed: May 30, 2014

(30) Foreign Application Priority Data
May 31, 2013 (SG) 201304230-4

(51) Int. Cl. G06Q 20/32; G06Q 20/20

(52) U.S. Cl. CPC G06Q 20/3255; G06Q 20/202
USPC 705/21

(57) ABSTRACT

A method and system for internet purchasing from a mobile phone handset is provided. The method includes a remote point-of-sale (POS) payment system determining card present information from payment information of the mobile phone handset via user transparent short messaging service (SMS) communication, wherein the payment information comprises one or more of credit card information and value-added services information. The method also includes the remote POS payment system forwarding the card present information to a merchant server and the merchant server transmitting the card present information to a payment acquirer system.

### FIELD

The present disclosure generally relates to methods and apparatus for financial transactions, and more particularly relates to methods and apparatus for card present transactions authenticated by Short Messaging Service (SMS).

### BACKGROUND

In today's world of internet merchandising, an individual can shop by surfing the web on his/her personal computer (PC). When the individual selects a merchant's website, his/her PC accesses the merchant's server and displays a screen which allows interaction with the merchant's server. If the individual decides to buy something from that merchant, a transaction is carried out by the individual entering his/her financial information (payment card information, coupon or voucher information, or loyalty code information), the merchant's server receiving that information, utilizing it to settle the transaction, and then notifying the individual that the transaction has been successful. This is a Card Not Present transaction and relies upon the payment card information entered in order to authenticate the transaction.

Card Present transactions include purchases made in person where the individual presents his credit or debit card (i.e., payment card) to the merchant who can authenticate the transaction by checking the signature on the back of the card against the individual's signature on a payment card slip or receipt. In addition, the merchant can authenticate the card by requesting photo identification from the individual and comparing the name on the identification with the name on the payment card.

With the introduction of other payment card formats (e.g., virtual cards and electronically stored cardlets), additional security (e.g., Card Code Verification (CCV) numbers associated with payment cards) and additional communication capabilities (such as near field communication (NFC)), Card Present transactions can be enabled for financial transactions that do not require presenting the payment card to the merchant. However, exchange of the payment card information (card number and additional security information) is still required. In addition, while Card Present transactions using cardlets or other electronic wallet entries can provide automatic, user-transparent payment card authentication, communication with the stored cardlets must be internet communication addressing a unique address such as the individual's email address and exchange of the payment card information (e.g., security data) is also required. If the cardlets are conveniently stored in a mobile device, the mobile device must be a device having mobile web-surfing capability enabled such as a smartphone.

Thus, what is needed is a method and system for mobile device web-based Card Present payment transaction settlement which at least partially overcomes the present drawbacks. Furthermore, other desirable features and characteristics will become apparent from the subsequent detailed description and the appended claims, taken in conjunction with the accompanying drawings and this background of the disclosure.

### SUMMARY

According to at least one embodiment of the present disclosure a method for internet purchasing from a mobile device is provided. The method includes a remote point-of-sale (POS) payment system determining card present information from payment information of the mobile device via short messaging service (SMS) communication, wherein the payment information comprises one or more of payment card information and value-added services information. The method also includes the remote POS payment system forwarding the card present information to a merchant server and the merchant server transmitting the card present information to a payment acquirer system.

In accordance with another aspect of at least one embodiment of the present disclosure, a system for internet purchasing is provided. The system includes a mobile device, a merchant server, and a remote point-of-sale (POS) payment system. The mobile device is configured to send and receive SMS communication. The merchant server hosts a merchant's website and initiates a payment transaction in response to the merchant's website receiving payment transaction information. The remote POS payment system obtains card present information from the mobile device via SMS communication, the remote POS payment system forwarding the card present information to the merchant server. In response to the forwarded card present information, the merchant server generates card present transaction information.

In accordance with yet another aspect of at least one embodiment of the present disclosure, a mobile device including a transceiver and a smartcard device is provided. The transceiver receives and forwards SMS signals to and from the mobile device. The smartcard device includes a subscriber identity module (SIM), a plurality of cardlets and a SMS handling device. The SMS handling device is coupled to the transceiver for enabling SMS communication with the plurality of cardlets and provides SMS communication of card present information from the plurality of cardlets via the transceiver to a remote POS payment system for determination of card present transaction information.

### DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with the present disclosure, by way of non-limiting example only, wherein:

FIG. 1, comprising FIGS. 1A and 1B, illustrates conventional methods for transaction settlement, where FIG. 1A illustrates a three-party system, while FIG. 1B illustrates a four-party system;

FIG. 2, comprising FIGS. 2A and 2B, illustrates an embodiment of a system for card present transaction settlement in a web purchase incorporating value-added services according to the present disclosure, wherein FIG. 2A illustrates a system whereby the web purchase is made from a web connected device other than the mobile device having the cardlets for the card present transaction settlement and FIG. 2B illustrates a system whereby the web purchase is made from the mobile device having the cardlets for the card present transaction settlement;

FIG. 3 illustrates a short messaging service (SMS) flow diagram for the system depicted in FIG. 2;

FIG. 4 illustrates a first SMS variant of the card present transaction settlement system depicted in FIG. 2;

FIG. 5 illustrates a second SMS variant of the card present transaction settlement system depicted in FIG. 2;

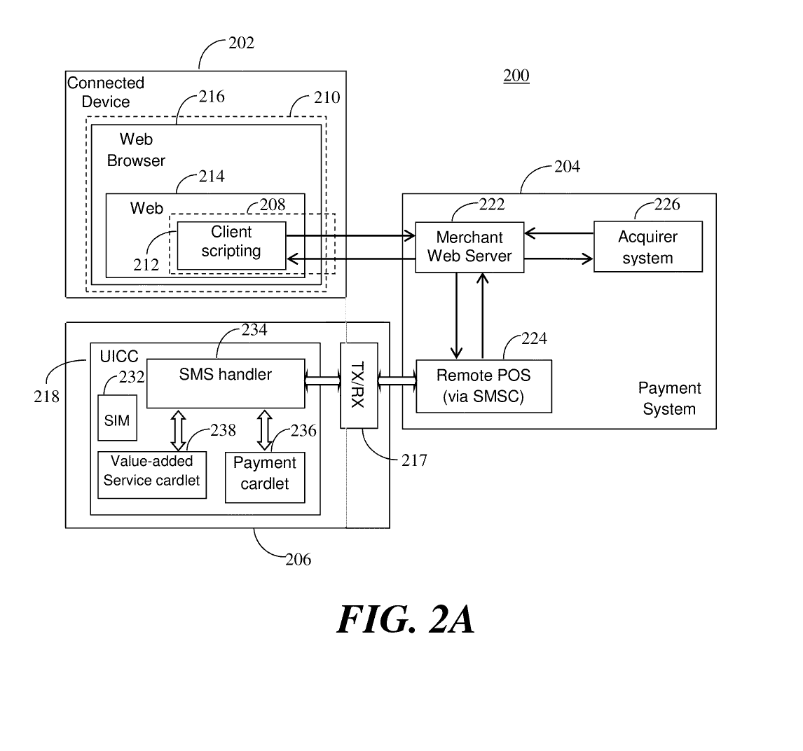

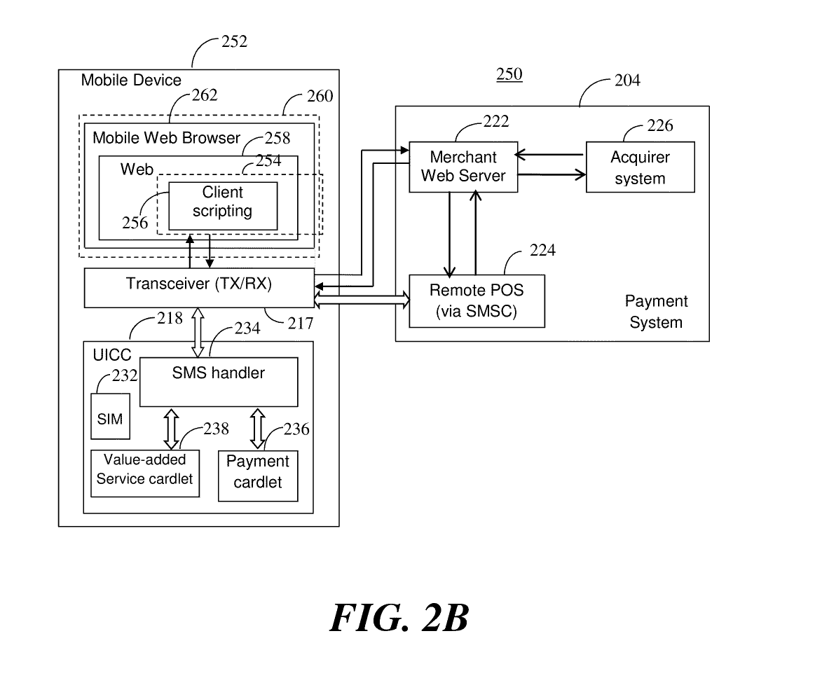

And FIG. 6 a third SMS variant of the card present transaction settlement system depicted in FIG. 2;

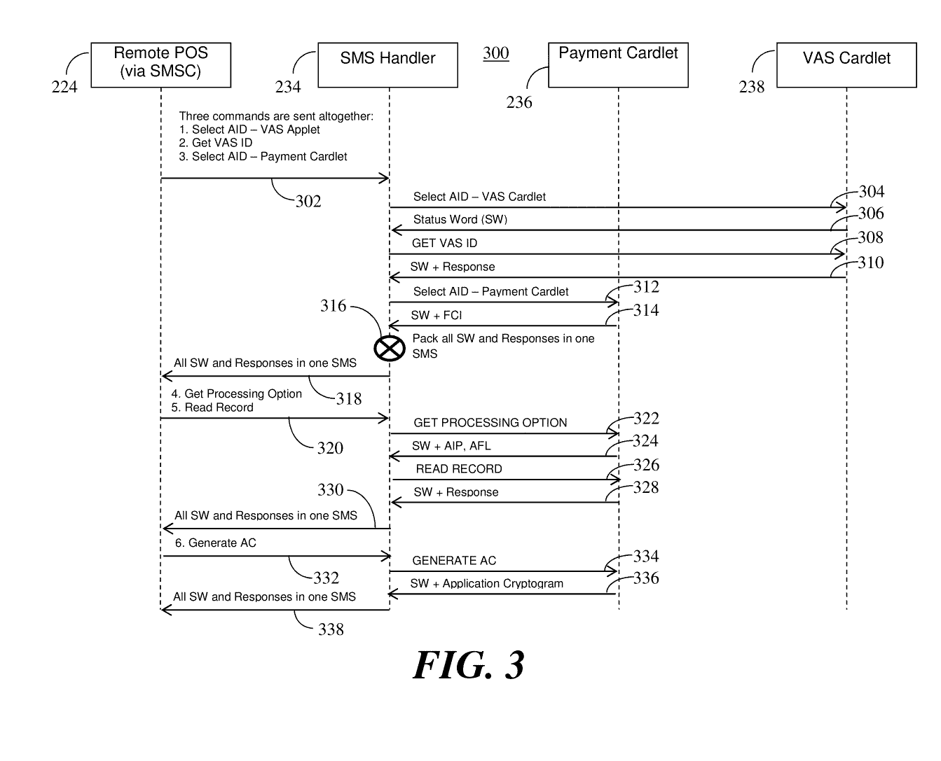

Skilled artisans will appreciate that elements in the figures are illustrated for simplicity and clarity and have not necessarily been depicted to scale. For example, the timing of some of the SMS messages in the SMS flow diagram of FIG. 3 may not be accurate in respect to timings of other SMS messages to help to improve understanding of the order of the SMS messages in accordance with the present embodiment.

### DETAILED DESCRIPTION

The following detailed description is merely exemplary in nature and is not intended to limit the disclosure or the application and uses of the embodiments herein. Furthermore, there is no intention to be bound by any theory presented in the preceding background of the disclosure or the following detailed description. It is the intent of this disclosure to present a system and method for card present transactions via short messaging service (SMS) communication.

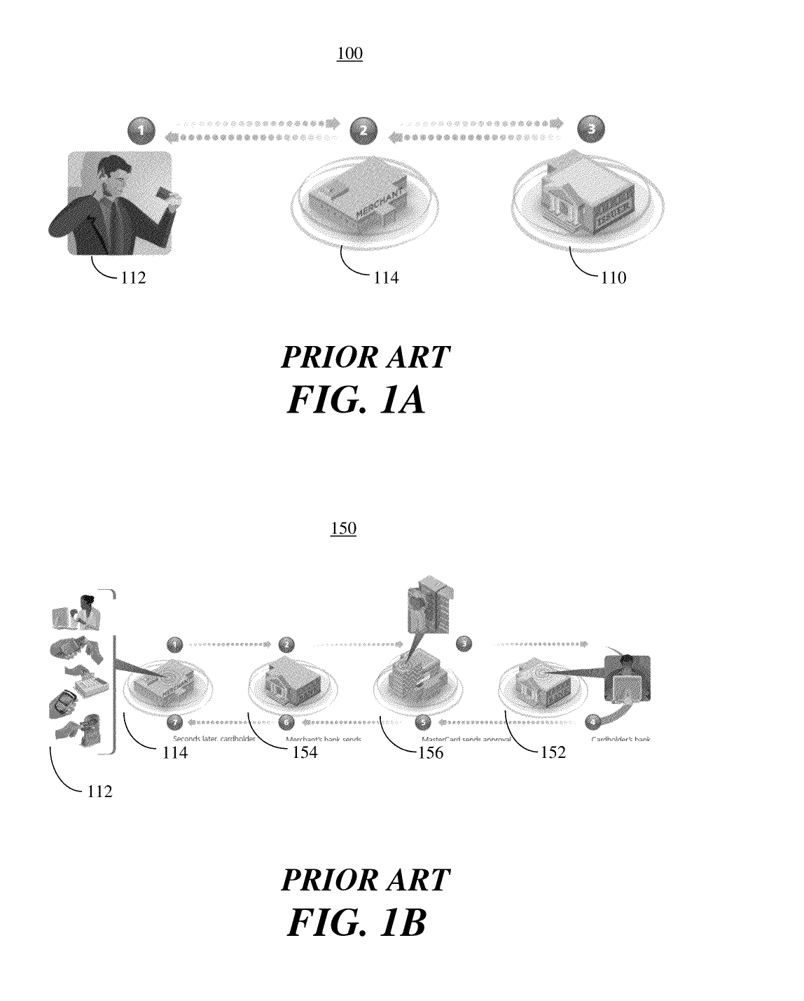

Referring to FIG. 1A, a diagram 100 illustrates a conventional three-party payment system for transaction settlement. A single firm 110 issues payment cards to individuals such as the individual 112, manages the network, and provides merchant card acceptance for merchants such as the merchant 114. As shown in the diagram 100, the individual 112 provides his/her information for making a purchase from the merchant 114 by providing his/her payment card issued by the firm 110 to the merchant 114. The merchant 114 sends the transaction data to the firm 110 that had issued the credit card. The firm 110 authorizes the transaction and sends an approval back to the merchant 114 who completes the sale of the item to the individual 112.

Referring to FIG. 1B, a diagram 150 illustrates a conventional four-party payment system for transaction settlement. In the four-party payment system, a payment card (e.g., debit card or credit card like a MasterCard®) is issued by a participating financial institution 152. When the individual 112 provides this information to the merchant 114, the merchant 114 contacts their acquiring bank 154 who contacts the payment card company 156 (e.g., MasterCard International) to facilitate authorization of the transaction. The payment card company 156 communicates the transaction to the issuing financial institution 152 who had issued the payment card to the individual 112 who then authorizes the transaction or not. Once authorized, the payment card company 156 passes an authorization message to the merchant's bank 154 which sends approval information to the merchant 114 for settlement of the transaction with the individual 112.

The present embodiment can be viewed as a modified payment system, as can be seen from the description herein. Referring to FIG. 2A a diagram 200 illustrates an embodiment of a system for card present transaction settlement in a web-initiated purchase. In addition to card payments, the present embodiment can also incorporate value-added services such as merchant vouchers, coupons or loyalty programs.

The diagram 200 includes a web connected device 202, a payment backend system 204 and a mobile device 206. The mobile device 206 is a wireless communication device having a wireless identification number and configured to send and receive SMS communication via the wireless identification number. The connected device 202 is a mobile device, a personal computer, a payment settlement device or any similar device which is configured to access and display website information by a processor 208 receiving client scripting 212 (e.g., java script) from servers coupled to an internet system such as the World Wide Web and utilizing the client scripting 212 from the internet system (i.e., the web 214) for display on a user interface 210 including a web browser 216.

A user of the connected device 202 in a manner well-known to those skilled in the art can “surf” the web 214. When the user accesses a webpage of a merchant which is hosted on a merchant web server 222, the webpage is displayed on the web 214. If the user wishes to buy something from the merchant 114, he initiates an internet purchase by a user input via the user interface 210 (e.g., a tap at a predetermined location on a touchscreen of the mobile phone handset corresponding to a displayed “PAYMENT” icon from the merchant's webpage). The client scripting 212 (e.g. a synchronous JAVA script such as an AJAX client) initiates a payment transaction without leaving the merchant webpage by communicating with the merchant's web server 222.

In accordance with the present embodiment, the mobile device 206 includes a transceiver 217 for wireless communication, a smartcard device 218, such as a universal integrated circuit card (UICC), which includes a subscriber identity module (SIM) 232, and a processor and memory (not shown). The smartcard device 218 also includes a SMS handling device 234 connected to a plurality of cardlets. A cardlet is an application and the plurality of cardlets can be stored in the memory. One or more of the plurality of cardlets can be compiled by the processor 254 and run thereon along with the SMS handling device 234. The plurality of cardlets includes at least one payment cardlet 236 and a value-added services cardlet 238. In accordance with the present embodiment, the SMS handling device 234 communicates with the plurality of cardlets via smartcard internal application programming interface (API) (e.g. via Java Card API or Java Card Shareable Interface) and via the transceiver 217 using a wireless identification number allocated to the SMS handling device 234 (such as a unique SMS address or unique SMS mobile number) to provide SMS communication of payment information.

The merchant web server 222 initiates a card present transaction in accordance with the present embodiment by contacting a remote point-of-sale (POS) payment system 224. A POS payment system, such as a PayPass® device, generates card present information via known means of communication (in the case of the PayPass device, typically near field communication (NFC)) when a credit card is brought near to or tapped on the POS payment system. In accordance with the present embodiment, the remote POS payment system 224 determines card present information via SMS communication with the SMS handling device 234, such as user transparent SMS communication via the transceiver 217, and, possibly, user acknowledgement from a user of the mobile device 206 via the SMS handling device 234. The user transparent SMS communication is enabled by the SMS handling device 234 having the unique SMS address/number which serves as destination identification in point-to-point SMS communication initiated by the remote POS payment system 224. This could be a telephone number or an electronic identification number (EIN) or a mobile identification number (MIN). Advantageously, this identification number or information associated with this identification number can be entered in the web-based transaction instead of sensitive payment card information, thereby protecting the security of the payment card information.

After determining the card present information, the remote POS payment system 224 confirms transaction status to the merchant web server 222. For example, if the remote POS payment system 224 determines that the mobile device 206 has a valid payment method (e.g., valid payment card, valid voucher or valid coupon), the card present information forwarded will indicate “Card Present”. If, on the other hand, the remote POS payment system 224 determines that the mobile device 206 does not have a valid payment method, the remote POS payment system 224 will indicate this to the merchant web server 222 so that the merchant web server 222 can contact the user of the connected device 202 to provide alternate payment means.

If the card present information received by the merchant web server 222 indicates “Card Present”, the merchant web server 222 sends “Card Present Transaction” to a payment acquirer system 226, such as a credit or debit card company 156 and the participating financial institution 152 (FIG. 1B). The payment acquirer system 226 responds to the merchant web server 222 with an acknowledgement, and the client scripting 212 (e.g., the AJAX client) receives the final payment transaction status from the merchant web server 222 and displays the status on an updated web page 214.

As can be seen, the card present information is determined by the remote POS system 224 from information obtained from the mobile device 206 via the user transparent SMS communication therebetween. This can be done by the remote POS system 224 calling the unique address/number for the SMS handling device 234. Thus, the mobile device 206 may be a mobile phone handset or a wireless-enabled pad. In accordance with the present embodiment, the mobile device 206 does not need to include mobile web browser capability (e.g., the mobile device may be a feature phone with no wireless web access capability).

With the introduction of mobile phones and other mobile devices capable of web surfing at any location (e.g., smartphones, pads), users of such mobile device can purchase items over the internet from their mobile devices. Referring to FIG. 2B, a diagram 250 illustrates a mobile device 252 which is configured to access and display website information by a processor 254 receiving client scripting 256 (e.g., java script) from servers coupled to the web 258 and utilizing the client scripting 256 for display on a user interface 260 including a web browser 262. Entry of financial, voucher and loyalty identification information may be problematic in a mobile device 252 such as a mobile phone handset. For example, balancing the handset in one hand and a payment card (such as a credit card or a debit card) in another when attempting a purchase while walking along the street or while commuting in mass transport vehicles is not only difficult, it is also dangerous as the payment card information is publically exposed when entering the card information. Use of the SMS communication-based payment authorization system in accordance with the present embodiment advantageously allows user transparent authorization via the wireless SMS communication between the remote POS system 224 and the SMS handling device 234 as described hereinabove.

Referring to FIG. 3, a SMS flow diagram 300 illustrates the SMS communication between the remote POS system 224 and the mobile device 206 in accordance with the present embodiment. More particularly, the SMS flow diagram 300 illustrates communication between the remote POS system 224 and the SMS handler 234, the at least one payment cardlet 236 and the value-added services cardlet 238 of the mobile device 206.

In the exemplary communication shown in the SMS flow diagram 300, a total of six SMS messages are exchanged between the remote POS system 224 and the SMS handler 234, three from the remote POS system 224 to the SMS handler 234 and three from the SMS handler 234 to the remote POS system 224. A first message 302 is sent from the remote POS system 224 to the SMS handler 234. The first message 302 includes commands for the SMS handler 234 to (1) obtain identification of an application for a value-added services (VAS) and identification of a VAS applet(s) from the value-added services cardlet 238, (2) obtain identification information of selected value-added service(s), and (3) obtain identification of an application for one of the one or more payment cardlets 236.

In response to receiving this first message 302, the SMS handler 234 first contacts 304 the value-added services cardlet 238 for identification of an application and a VAS applet. This could, for example, cause the mobile phone handset 206 to display a request to the user to indicate a merchant voucher to use, or identify to the user a coupon that could be applied to the transaction, or identify to the user loyalty points that could be used for the purchase. The user could then provide selection information to the smartcard device 218 to select a value-added service for use in the transaction. Alternatively, the value-added services cardlet 238 could determine the most beneficial application of value-added services available and applicable to the proposed transaction in response to the message 304 and request authorization from the user of the application of these value-added services to the transaction. Further, the user could provide a pre-selection of value-added services for this particular transaction or predetermined criteria for automatic application of value-added services. Whatever instructions the value-added services cardlet 238 has or receives, the value-added services cardlet 238 forwards a status word (SW) 306 to the SMS handler 234 corresponding to the selected application identification information and VAS applet(s).

Next, the SMS handler 234 sends a message 308 to the value-added services cardlet 238 to obtain identification information for the selected value-added service(s), and the value-added services cardlet 238 provides a message 310 containing a status word and responsive identification information to the SMS handler 234.

Then, the SMS handler 234 sends a message 312 to the payment cardlet 236 to obtain application identification information and financial card information for the mode of payment from the payment cardlet 236. In response, the payment cardlet 236 provides a message 314 containing a status word and responsive financial card information to the SMS handler 234.

The SMS handler 234 then packs 316 all of the status words, responses and financial card information into a single message and sends this message as a second message 318 (of the six user transparent messages) to the remote POS system 224. Then a third message 320 is sent from the remote POS system 224 to the SMS handler 234. The third message 320 includes two additional commands: (4) for the SMS handler 234 to obtain payment processing option information, and (5) for the SMS handler 234 to read the payment cardlet 236 record.

In response to receiving the third message 320, the SMS handler 234 signals 322 the payment cardlet 236 to provide the payment processing information. The payment cardlet 236 responds 324 by providing a status word and application interchange profiles (AIP), as well as application file location (AFL). Next, the SMS handler 234 signals 326 the payment cardlet 236 to read the payment cardlet 236 record. The payment cardlet 236 responds 328 by providing a status word and the “read record” response which includes cardholder information and issuer risk parameters.

The SMS handler 234 then sends all of the status words, responses and information into a single message and sends this message as a fourth message 330 (of the six user transparent messages) to the remote POS system 224. Then a fifth message 332 is sent from the remote POS system 224 to the SMS handler 234 commanding the SMS handler 234 to send an acknowledgement command. In response to receiving the fifth message 332, the SMS handler 234 signals 334 the payment cardlet 236 to generate the acknowledgement command. The payment cardlet 236 generates the command and forwards 336, to the SMS handler 234, a status word and application cryptogram, the application cryptogram generated for use by the remote POS system 224 to decode all of the messages received. The SMS handler 234 then sends a sixth message 338 to the remote POS system 224 including the status word and the application cryptogram.

Those skilled in the art will understand that the flow diagram 300 is representation of just one SMS communication scheme for the remote POS system 224 to obtain sufficient information from the mobile device 206 to determine card present information. In accordance with the present embodiment, this information will include not only payment card information, but also value-added services information. Depending upon message size and other communication system parameters and the information exchanged more or fewer messages may be utilized to exchange sufficient information for card present transaction settlement in accordance with the present embodiment.

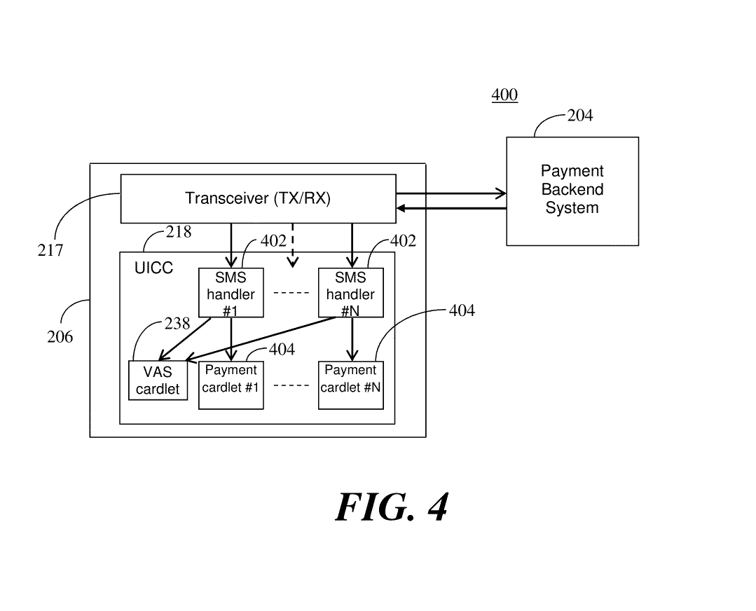

Also, the configuration of the SMS handler 234, the one or more payment cardlets 236 and the value-added services cardlet 238 shown in the diagrams 200, 250 is not the only possible configuration. Several variants are shown in FIGS. 4 to 6. Referring to FIG. 4, a diagram 400 illustrates a first SMS variant of the mobile device 206 in accordance with the present embodiment. The SMS handling device 234 includes a plurality of SMS handlers 402. Each of a plurality of payment cardlets 404 is connected to a corresponding one of the plurality of SMS handlers 402. In addition, each of the plurality of SMS handlers 402 is also connected to the value-added services cardlet 238.

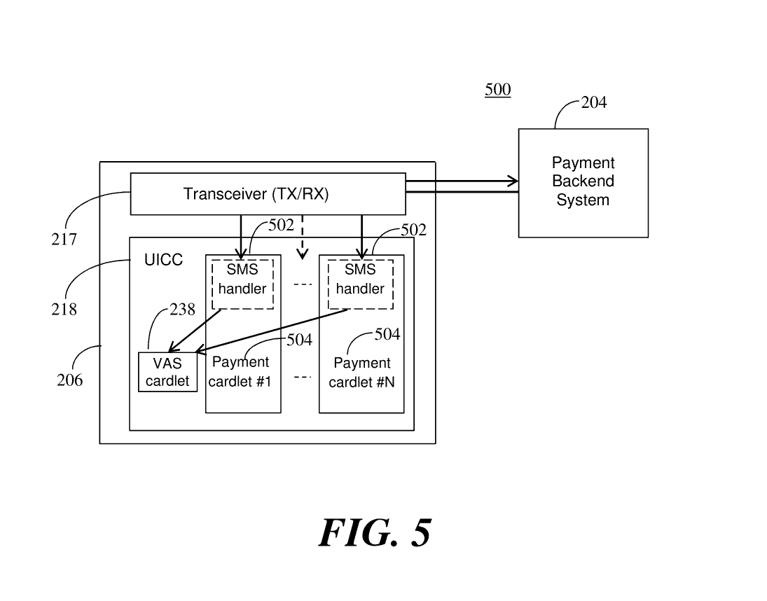

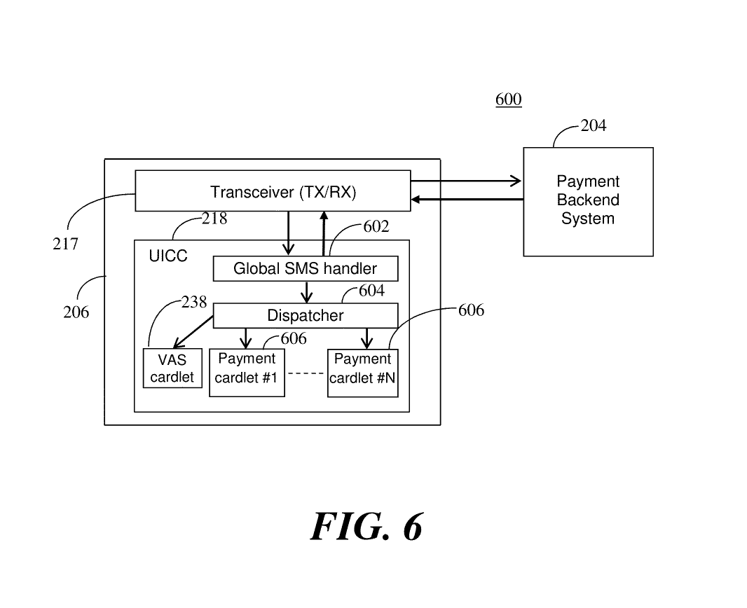

Referring to FIG. 5, a diagram 500 illustrates a second SMS variant of the mobile device 206 in accordance with the present embodiment. The SMS handling device 234 includes a plurality of SMS handlers 502. Each of the plurality of SMS handlers 502 is incorporated in one of a plurality of payment cardlets 504. In addition, each of the plurality of SMS handlers 502 is also connected to the value-added services cardlet 238.

Referring to FIG. 6, a diagram 600 illustrates a third SMS variant of the mobile device 206 in accordance with the present embodiment. The SMS handling device 234 comprises a global SMS handler 602. The smartcard device 218 also includes a dispatcher 604 connected to the global SMS handler 602. The dispatcher 604 is connected to the plurality of payment cardlets 606 and the value-added services cardlet 238 for coordinating communication between the global SMS handler 602 and the plurality of cardlets 606 and the value-added services cardlet 238.

Thus, it can be seen that the present embodiment can provide an automatic, user-transparent system for web-based transaction settlement that uses a mobile device including both payment card and value-added service information wherein a wireless device number is transferred for transaction settlement instead of the payment card information. In addition, it provides advantageous methods for card present transactions with payment cards and value-added services in a user-transparent web-based transaction settlement system for mobile devices. While exemplary embodiments have been presented in the foregoing detailed description, it should be appreciated that a vast number of variations exist.

It should further be appreciated that the exemplary embodiments are only examples, and are not intended to limit the scope, applicability, operation, or configuration of the disclosure in any way. Rather, the foregoing detailed description will provide those skilled in the art with a convenient road map for implementing an exemplary embodiment of the disclosure, it being understood that various changes may be made in the function and arrangement of elements and method of operation described in an exemplary embodiment without departing from the scope of the disclosure as set forth in the appended claims.

1. A method for internet purchasing from a connected device comprising:
a remote point-of-sale (POS) payment system determining card present information from payment information of a mobile device via short messaging service (SMS) communication, wherein the payment information comprises one or more of payment card information and value-added services information;
the remote POS payment system forwarding the card present information to a merchant server; and
the merchant server transmitting the card present information to a payment acquirer system.

2. The method in accordance with claim 1 wherein the payment card information comprises information corresponding to one or more payment cards.

3. The method in accordance with claim 1 wherein the value-added services information comprises information selected from the group comprising product coupon information, merchant voucher information, and merchant loyalty program information.

4. The method in accordance with claim 1 wherein the step of obtaining the card present information via the SMS communication comprises the remote POS payment system sending one or more SMS messages requesting information selected from the group of information comprising selecting value-added services, obtaining identification information for the value-added services, obtaining identification information for payment cards, and obtaining payment card processing information.

5. The method in accordance with claim 1 wherein the step of obtaining the card present information via the SMS communication comprises the mobile device receiving and transmitting one or more SMS messages comprising information selected from the group of information comprising selecting value-added services, identification information for the value-added services, identification information for payment cards, and payment card processing information.

6. The method in accordance with claim 1 further comprising:
displaying an internet webpage on a connected device, the internet webpage hosted on the merchant server;
transmitting a communication to the merchant server in response to a user input initiating a payment transaction on the internet webpage displayed on the connected device; and
the merchant server contacting the remote POS payment system for the card present information.

7. The method in accordance with claim 1 further comprising;
the acquirer system acknowledging reception of the card present information; and
the merchant server updating information on the webpage to indicate payment status in response to the acquirer system acknowledging reception of the card present information.

8. A system for internet purchasing comprising:
a merchant server for hosting a merchant's website and for initiating a payment transaction in response to the merchant's website receiving payment transaction information; and
a remote point-of-sale (POS) payment system for obtaining card present information from a mobile device via short message service communication, the remote POS payment system forwarding the card present information to the merchant server and the merchant server generating card present transaction information in response to the card present information, wherein the card present information from the mobile device includes payment card information and value-added services information.

9. (canceled)

10. The system in accordance with claim 8 further comprising the mobile device, and wherein the mobile device includes one or more of a mobile phone handset and a smartcard device including a subscriber identity module (SIM), the smartcard device having one or more cardlets operating therein.

11. The system in accordance with claim 8 wherein the remote POS payment system communicates with the mobile device to determine the card present information by sending and receiving SMS messages comprising information selected from the group of information comprising selecting value-added services, identification information for the value-added services, identification information for payment cards, and payment card processing information.

12. (canceled)

13. (canceled)

14. The system in accordance with claim 8 wherein the mobile device comprises a smartcard device including a subscriber identity module (SIM), the smartcard device having one or more cardlets operating therein; and wherein the one or more cardlets comprise one or more of a payment cardlet for providing the payment card information corresponding to one or more payment cards and a value-added services cardlet for providing the value-added services information selected from the group comprising product coupon information, merchant voucher information, and merchant loyalty program information.

15. (canceled)

16. The system in accordance with claim 8 further comprising a connected device coupled to the merchant server and transmitting a communication to the merchant server in response to a user input initiating a payment process on an internet webpage displayed on the connected device that is hosted on the merchant server,
and wherein the merchant server contacts the remote POS payment system for the card present information in response to the communication.

17. The system in accordance with claim 16 wherein the connected device includes the mobile device.

18. A mobile device comprising:
a transceiver for receiving and forwarding short messaging service (SMS) signals to and from the mobile device;
a smartcard device comprising:
a subscriber identity module (SIM);
a plurality of cardlets; and
a SMS handling device coupled to the transceiver for enabling SMS communication with the plurality of cardlets, the SMS handling device providing SMS communication of card present information from the plurality of cardlets via the transceiver to a remote POS payment system for determination of card present transaction information.

19. The mobile device in accordance with claim 18 wherein the plurality of cardlets comprise a value-added services cardlet and at least one payment cardlet, the value-added services cardlet including information selected from the group comprising product coupon information, merchant voucher information, and merchant loyalty program information.

20. The mobile device in accordance with claim 19 wherein the at least one payment cardlet comprises a plurality of payment cardlets for storing and providing payment card information, each of the plurality of payment cardlets comprising payment card information corresponding to one of a plurality of payment cards associated with the user.

21. The mobile device in accordance with claim 20 wherein the SMS handling device comprises a plurality of SMS handlers, and wherein each of the plurality of payment cardlets comprises one of the plurality of SMS handlers, each of the plurality of SMS handlers incorporated in respective ones of the plurality of payment cardlets also being connected to the value-added services cardlet.

22. The mobile device in accordance with claim 20 wherein the SMS handling device comprises a plurality of SMS handlers, and wherein each of the plurality of payment cardlets is connected to a corresponding one of the plurality of SMS handlers, each of the plurality of SMS handlers also connected to the value-added services cardlet.

23. The mobile device in accordance with claim 20 wherein the SMS handling device comprises a global SMS handler, and wherein the smartcard device further includes a dispatcher connected to the global SMS handler for coordinating communication between the global SMS handler and the plurality of cardlets, the dispatcher connected to the plurality of payment cardlets and the value-added services cardlet.

24. The mobile device in accordance with claim 18 further comprising:
a user interface to present information to a user including displaying information, the user interface also configured to receive user inputs; and
a processor coupled to the transceiver for enabling mobile web browsing, the processor also coupled to the user interface to provide information to the user interface for displaying website information to the user and for receiving user inputs from the user interface to initiate a payment process on an internet webpage of the website information displayed on the user interface.
